(19) United States
(12) Patent Application Publication
(10) Pub. No.: US 2024/0080658 A1
(43) Pub. Date: Mar. 7, 2024

(54) METHOD AND APPARATUS FOR SIDELINK RELAY COMMUNICATION

(71) Applicant: ZTE Corporation, Shenzhen (CN)

(72) Inventors: Lin Chen, Shenzhen (CN); Wei Luo, Shenzhen (CN); Ying Huang, Shenzhen (CN); Weiqiang Du, Shenzhen (CN); Mengzhen Wang, Shenzhen (CN)

(73) Assignee: ZTE Corporation, Shenzhen (CN)

(21) Appl. No.: 18/505,710

(22) Filed: Nov. 9, 2023

Related U.S. Application Data
(63) Continuation of application No. PCT/CN2021/092620, filed on May 10, 2021.

(51) Int. Cl. H04W 8/22; H04W 8/00; H04W 68/02

(52) U.S. Cl. CPC H04W 8/22; H04W 8/005; H04W 68/02; H04W 92/18

(57) ABSTRACT

Sidelink based relay communications include communications through a relay user equipment (“UE”) between a basestation and a remote UE. Relay communications can be improved by addressing incompatibilities between different devices, which support different features/operations, such as the layers of communication. Access control and an establishment cause value can also be addressed by the relay communications. Paging identification and system information can be communicated by relay communications, such as through the relay UE to improve communications.

### PRIORITY

This application claims priority to PCT/CN2021/092620, filed on May 10, 2021, entitled “METHOD AND APPARATUS FOR SIDELINK RELAY COMMUNICATION”, published as WO 2022/236533 A1, the entire disclosure of which is hereby incorporated by reference.

### TECHNICAL FIELD

This document is directed generally to wireless communications. More specifically, the wireless communications include sidelink based relay communications for device to device communications.

### BACKGROUND

Wireless communication technologies are moving the world toward an increasingly connected and networked society. Wireless communications rely on efficient network resource management and allocation between user mobile stations and wireless access network nodes (including but not limited to wireless base stations). A new generation network is expected to provide high speed, low latency and ultra-reliable communication capabilities and fulfil the requirements from different industries and users. User mobile stations or user equipment (“UE”) are becoming more complex and the amount of data communicated continually increases. With the development of wireless multimedia services, demands of high data rate services are increasing as well as the requirements for system capacity and coverage of conventional cellular network. In addition, increased usage for public safety, social network, short distance data sharing, local advertisement, and other demands of proximity services which allow people to communicate with adjacent people or objects are also increasing. Device-to-device (D2D) communication technology may serve such demands. In order to improve communications and meet reliability requirements for the vertical industry as well as support the new generation network service, communication improvements for D2D should be made.

### SUMMARY

This document relates to methods, systems, and devices for sidelink based relay communication that extend coverage and improve power consumption of a network. Sidelink based relay communications include communications through a relay user equipment (“UE”) between a basestation and a remote UE. Relay communications may be referred to as UE-to-Network relay operation and can be improved by addressing incompatibilities between different devices, which support different features/operations such as the layers of communication. Access control and an establishment cause value can also be addressed by the relay communications. Paging identification and system information can be communicated by relay communications, such as through the relay UE to improve communications.

In one embodiment, a method for wireless communication includes receiving an indication of relay capability in layer 2 or layer 3 and acting as a relay based on the indication of the relay capability. The indication is received by a relay user equipment (“UE”) from a basestation and the relay UE acts as the relay between the relay UE and a remote UE. The relay capability includes that the basestation can support layer 2 relay only, can support layer 3 only, or can support both layer 2 and layer 3. The relay capability can support both layer 2 and layer 3, the relay capability selected for the relay UE acting as the relay is based on an indication of preference from the remote UE or from an upper layer of relay UE. The acting is as a relay including sidelink discovery or sidelink communication. A system information block (“SIB”) includes the indication.

In another embodiment, a method for wireless communication includes receiving an indication of relay capability in layer 2 and layer 3, checking an authorization for UE-to-Network Relay discovery and communication based on the indication, and sending a sidelink relay configuration based on the relay capability and the authorization. The indication is provided from a relay capable user equipment (“UE”) to a basestation, and the basestation checks an indication about the UE authorization status for the UE-to-Network Relay discovery and communication.

In another embodiment, a method for wireless communication includes initiating a connection based on a relay capability in layer 2 or layer 3, receiving an indication for a preference for the relay capability between layer 2 or layer 3, and communicating based on the preference. The receiving is from a relay user equipment (“UE”) that acts as a relay between a basestation and a remote UE. The indication is received from the remote UE and the communicating is with the remote UE.

In another embodiment, a method for wireless communication includes receiving an indication that relay user equipment (“UE”) is barred, and performing reselection of the relay UE or suspending a sidelink transmission with the relay UE for UE-to-Network relay operation. The indication that the relay UE is barred is based on a unified access control (“UAC”).

In another embodiment, a method for wireless communication includes receiving information for paging monitoring of a remote user equipment (“UE”), monitoring a paging occasion for the remote UE, and sending, based on the monitoring, a paging indication to the remote UE. The method further includes providing information for paging monitoring to a relay UE in a PC5 message. The relay UE receives a paging message from a basestation and receives the paging indication from a remote UE based on the monitoring from the remote UE. The monitoring and the sending is from the relay UE. The paging indication is delivered through a PC5 RRC message. The paging indication includes radio access network (“RAN”) paging or core network (“CN”) paging of the remote UE. The sending includes forwarding a paging message to a plurality of remote UEs via groupcast.

In another embodiment, a method for wireless communication includes receiving a short message from basestation, and forwarding information in the short message to a remote user equipment (“UE”). The forwarding occurs when systemInfoModification or etwsAndCmasIndication is set to 1. The receiving is by a relay UE. The receiving is from a basestation.

In one embodiment, a wireless communications apparatus comprises a processor and a memory, and the processor is configured to read code from the memory and implement any of the embodiments discussed above.

In one embodiment, a computer program product comprises a computer-readable program medium code stored thereupon, the code, when executed by a processor, causes the processor to implement any of the embodiments discussed above.

In some embodiments, there is a wireless communications apparatus comprising a processor and a memory, wherein the processor is configured to read code from the memory and implement any methods recited in any of the embodiments. In some embodiments, a computer program product comprising a computer-readable program medium code stored thereupon, the code, when executed by a processor, causing the processor to implement any method recited in any of the embodiments. The above and other aspects and their implementations are described in greater detail in the drawings, the descriptions, and the claims.

### BRIEF DESCRIPTION OF THE DRAWINGS

FIG. 1 shows an example basestation.

FIG. 2 shows an example random access (RA) messaging environment.

FIG. 3 shows an example device to device messaging environment.

FIG. 4 shows a user plane protocol stack for layer 2 relay communications.

FIG. 5 shows a user plane protocol stack for layer 3 relay communications.

FIG. 6a shows relay communications for a basestation that supports layer 2.

FIG. 6b shows relay communications for a basestation that supports layer 3.

FIG. 6c shows relay communications for a basestation that supports both layer 2 and layer 3.

FIG. 6d shows relay communications for a basestation that supports neither layer 2 or layer 3.

FIG. 7 shows relay communications for sending a relay indication to a basestation.

FIG. 8 shows relay communications for sending destination identification to a basestation.

FIG. 9a shows relay communications for sending a relay indication to a basestation that supports layer 2.

FIG. 9b shows relay communications for sending a relay indication to a basestation that supports layer 3.

FIG. 9c shows relay communications for sending a relay indication to a basestation that supports both layer 2 and layer 3.

FIG. 10 shows relay communications with a setting of an establishment clause value.

FIG. 11 shows relay communications including access restrictions.

FIG. 12 shows relay communications with a paging indication.

FIG. 13 shows relay communications with paging for system information.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

Radio resource control (“RRC”) is a protocol layer between UE and the basestation at the IP level (Network Layer). There may be various Radio Resource Control (RRC) states, such as RRC connected (RRC_CONNECTED), RRC inactive (RRC_INACTIVE), and RRC idle (RRC_IDLE) state. RRC messages are transported via the Packet Data Convergence Protocol (“PDCP”). UE can transmit infrequent (periodic and/or non-periodic) data in RRC_INACTIVE state without moving to an RRC_CONNECTED state. This can save the UE power consumption and signaling overhead. This can be through a Random Access Channel (“RACH”) protocol scheme or a Configured Grant (“CG”) scheme. The communications described herein may be specific to relay communications, which may also be referred to as device to device (“D2D”) or sidelink communications.

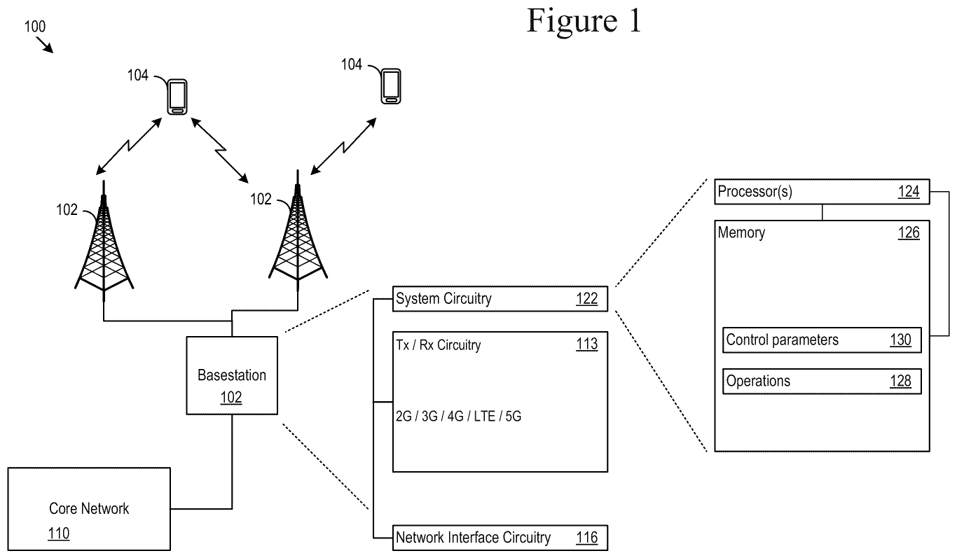

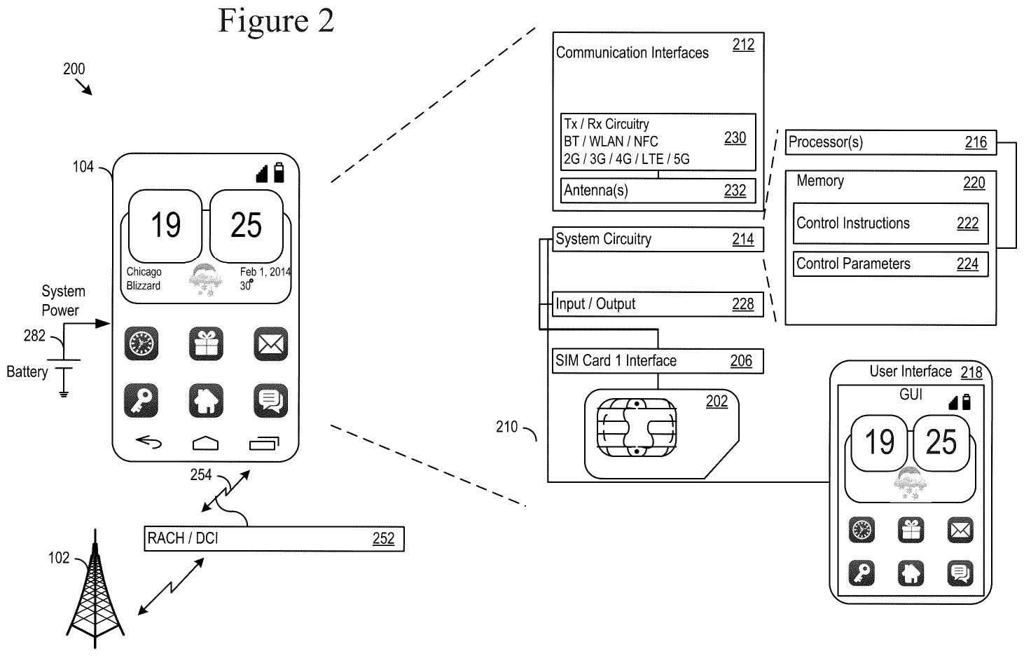

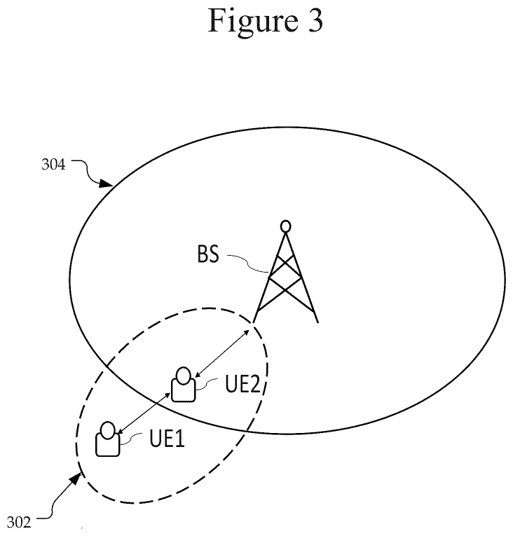

D2D or relay communications may relieve the burden of the cellular network, power consumption of user equipment (“UE”) can be reduced, data rates can be increased, and robustness of network infrastructures can be improved, all of which can fulfill the demands of high data rate services and the proximity services. The relay communications or D2D technology may also be referred to as a proximity service (“ProSe”) or sidelink communications. An interface between equipment may be known as or referred to as a PC5 interface. PC5 is where the UE directly communicates with another UE over a direct channel without the basestation. In some embodiments, the sidelink-based relay communication may be applied to indoor relay communication, smart farming, smart factory and public safety services. FIG. 3 shows exemplary embodiments for sidelink communication. FIGS. 1-2 show example basestations and user equipment and messaging environments which may be applicable to sidelink communications.

FIG. 1 shows an example basestation 102. The basestation may also be referred to as a wireless network node. The basestation 102 may be further identified to as a nodeB (NB, e.g., an eNB or gNB) in a mobile telecommunications context. The example basestation may include radio Tx/Rx circuitry 113 to receive and transmit with user equipment (UEs) 104. The basestation may also include network interface circuitry 116 to couple the basestation to the core network 110, e.g., optical or wireline interconnects, Ethernet, and/or other data transmission mediums/protocols.

The basestation may also include system circuitry 122. System circuitry 122 may include processor(s) 124 and/or memory 126. Memory 126 may include operations 128 and control parameters 130. Operations 128 may include instructions for execution on one or more of the processors 124 to support the functioning the basestation. For example, the operations may handle random access transmission requests from multiple UEs. The control parameters 130 may include parameters or support execution of the operations 128. For example, control parameters may include network protocol settings, random access messaging format rules, bandwidth parameters, radio frequency mapping assignments, and/or other parameters.

FIG. 2 shows an example random access messaging environment 200. In the random access messaging environment a UE 104 may communicate with a basestation 102 over a random access channel 252. In this example, the UE 104 supports one or more Subscriber Identity Modules (SIMs), such as the SIM1 202. Electrical and physical interface 206 connects SIM1 202 to the rest of the user equipment hardware, for example, through the system bus 210.

The mobile device 200 includes communication interfaces 212, system logic 214, and a user interface 218. The system logic 214 may include any combination of hardware, software, firmware, or other logic. The system logic 214 may be implemented, for example, with one or more systems on a chip (SoC), application specific integrated circuits (ASIC), discrete analog and digital circuits, and other circuitry. The system logic 214 is part of the implementation of any desired functionality in the UE 104. In that regard, the system logic 214 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, Internet connectivity; establishing, maintaining, and terminating wireless network connections, Bluetooth connections, or other connections; and displaying relevant information on the user interface 218. The user interface 218 and the inputs 228 may include a graphical user interface, touch sensitive display, haptic feedback or other haptic output, voice or facial recognition inputs, buttons, switches, speakers and other user interface elements. Additional examples of the inputs 228 include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

The system logic 214 may include one or more processors 216 and memories 220. The memory 220 stores, for example, control instructions 222 that the processor 216 executes to carry out desired functionality for the UE 104. The control parameters 224 provide and specify configuration and operating options for the control instructions 222. The memory 220 may also store any BT, WiFi, 3G, 4G, 5G or other data 226 that the UE 104 will send, or has received, through the communication interfaces 212. In various implementations, the system power may be supplied by a power storage device, such as a battery 282

In the communication interfaces 212, Radio Frequency (RF) transmit (Tx) and receive (Rx) circuitry 230 handles transmission and reception of signals through one or more antennas 232. The communication interface 212 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium.

The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 212 may include transceivers that support transmission and reception under the 2G, 3G, BT, WiFi, Universal Mobile Telecommunications System (UMTS), High Speed Packet Access (HSPA)+, and 4G/Long Term Evolution (LTE) standards. The techniques described below, however, are applicable to other wireless communications technologies whether arising from the 3rd Generation Partnership Project (3GPP), GSM Association, 3GPP2, IEEE, or other partnerships or standards bodies.

FIG. 3 shows an example device to device messaging environment. The device to device (“D2D”) messaging may also be referred to as sidelink messaging, sidelink communications, sidelink relay, or relay communications. FIG. 3 illustrates a basestation (“BS”) with a communication range 304. A second user equipment (“UE2”) is within the range of the BS's communication range 304, while a first user equipment (“UE1”) is out of the range of the communication range 304. The UE1 and UE2 establish relay communications 302 through which UE2 is the relay UE and UE1 is the remote UE. For relay communications, a remote UE (UE1) communicates with the network through a relay UE (UE2). The relay UE (UE2) relays communications between the basestation (BS) and the remote UE (UE1). In some embodiments, relay communications may be designed for UE1 in an area with weak or no coverage. UE1 is allowed to communicate with the basestation BS through a relay UE (UE2). As a result, the coverage of the network 304 is extended out to include the relay communication coverage area 302 (including UE1) and the capacity of the network is enlarged.

In some embodiments, such as during emergency situations (e.g. earthquake), the cellular network may operate abnormally or a sidelink communication range of the network may need to be extended. Thus, the relay communications may be designed for allowing multiple UEs to communicate with each other via the relay UE. Although not shown, there may be multiple UEs in a relay communication chain, or a relay UE may have multiple remote UEs. The interface in FIG. 3 between the UE and BS during relay communications is referred to as the Uu interface.

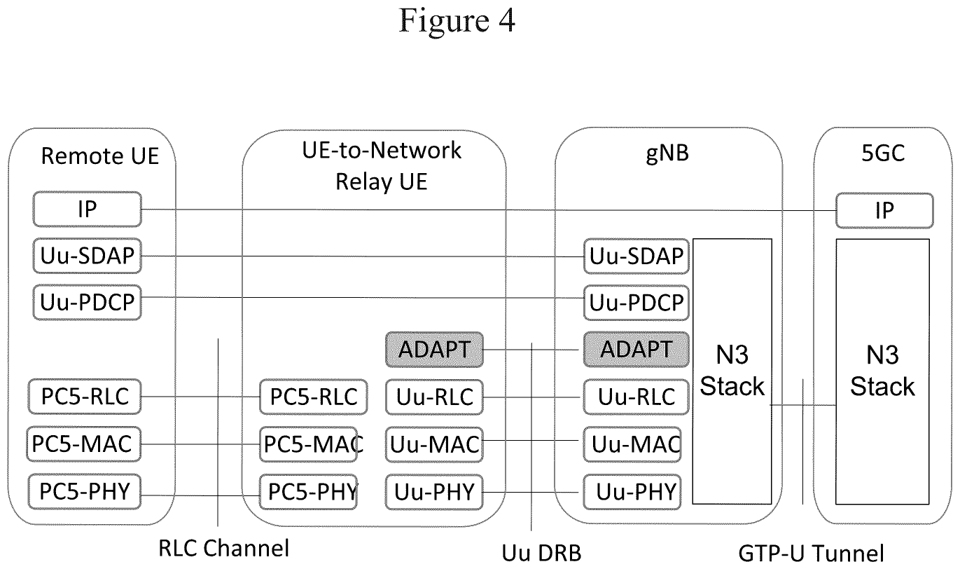

There are at least two technical schemes including an internet protocol (“IP”) layer (Layer 3 or “L3”) and an access layer (Layer 2 or “L2”) for the relay communications. The layer 3 based relay forwards data according to IP information (e.g. IP address or IP port number) of the UE. The layer 2 based relay routes and forwards data of user plane and control plane in access layer, allowing network operator (i.e. core network and/or the BS) to manage the remote UE more effectively. Mechanisms of new radio (“NR”) sidelink communications are different from those of earlier versions (e.g.) of sidelink communications (at frame structure, quality-of-service processing, bearer configurations, bearer establishments, etc.). FIGS. 4-9c relate to handling the coexistence of L2 and L3, control plane procedure for the support of L2 and L3 relay.

FIG. 4 shows a user plane protocol stack for layer 2 (“L2”) relay communications. L2 is also referred to as the access layer. For L2 UE-to-Network Relay, an adaptation layer (“ADAPT” in FIG. 4) may be placed over a radio link control (“RLC”) sublayer at the Uu interface between the relay UE and basestation (labeled as nNB). The Uu Service Data Adaptation Protocol (“SDAP”)/Packet Data Convergence Protocol (“PDCP”) and Radio Resource Control (“RRC”) are terminated between the Remote UE and the basestation, while radio link control (“RLC”), MAC and PHY are terminated in each link e.g. the link between the remote UE and the relay UE and the link between relay UE and the basestation.

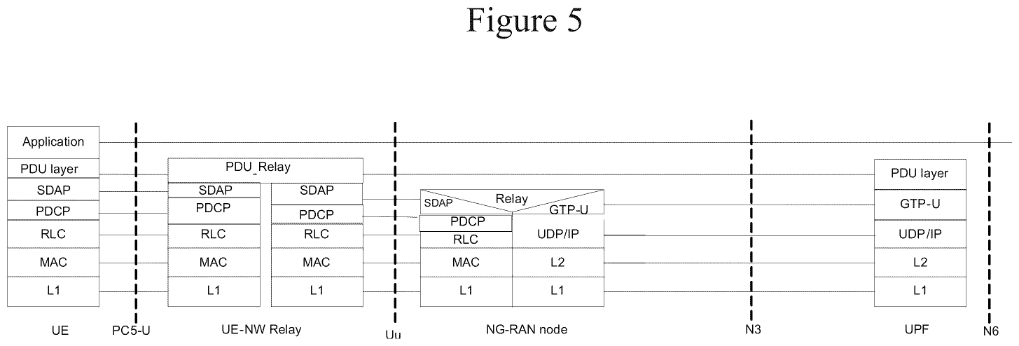

FIG. 5 shows a user plane protocol stack for layer 3 (“L3”) relay communications. L3 is also referred to as the internet protocol (“IP”) layer. L3 relay provides a generic L3 forwarding function that can relay any type of IP traffic between the remote UE and the network. The basestation may not be aware of the existence of the remote UE in L3. The remote UE's traffic may be treated as the relay UE's traffic.

### Basestation Layer Support

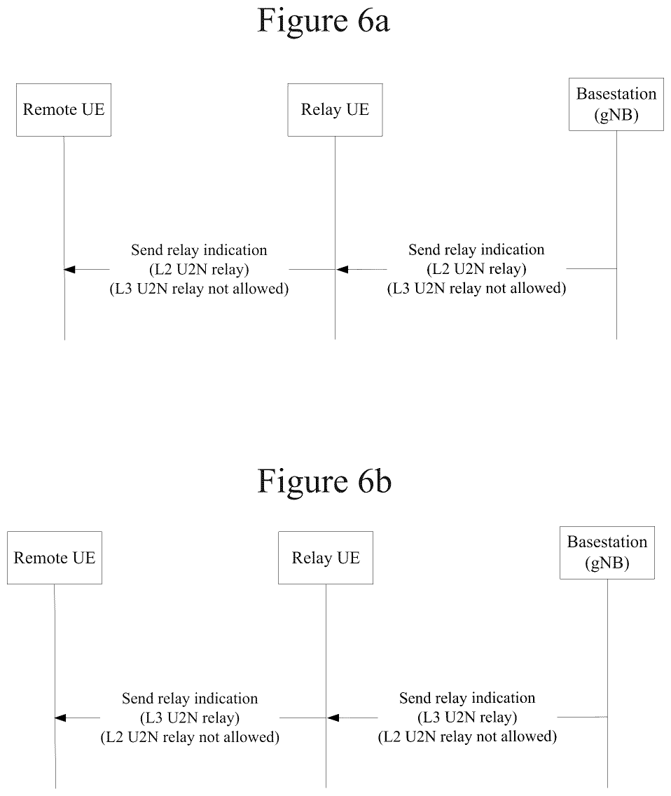

Both L2 and L3 relay communications are supported in 5G NR. However, different basestations, relay UEs and remote UEs may support different types of relay operations, which may affect cell selection and relay selection. Specifically, basestations, relay UEs, and remote UEs may only support L2 or L3, may support both L2 and L3, or may support neither L2 nor L3. Based on this compatibility of support, relay communications may be modified. This may be referred to as relay compatibility or layer compatibility. FIGS. 6a-8 relate to changing support (for L2 and/or L3) of the basestation.

FIG. 6a shows relay communications for a basestation that supports layer 2. If the basestation supports L2 relay, may be able to support L3 relay in some embodiments, since L3 relay only requires the basestation to configure several thresholds for relay discovery and selection. However, network operators may establish different policies for the UE-to-Network relay support. Some operators may prefer stricter network control, which may result in support for the L2 relay and not the L3 relay. In this example, the basestation can indicate that the L3 relay is not allowed. Further, the basestation may explicitly indicate that it allows L2 relay, as shown in FIG. 6a. The basestation provides a relay indication that indicates support for L2 user to network (“U2N”) relay. The relay indication may also indicate that L3 U2N relay is not supported. The relay indication can be used so that the L2 capable relay UE may initiate the discovery transmission/reception. In order for the RRC_IDLE/RRC_INACTIVE relay UE to be able to detect the relay type supported by the basestation, the basestation may broadcast the relay indications via a system information block (“SIB”).

FIG. 6b shows relay communications for a basestation that supports layer 3. If the network operator prefers less network control for UE-to-Network relay, the basestation may be implemented to only support L3 relay. In this example, the basestation can indicate that the L2 relay is not allowed and the basestation may explicitly indicate that it allows L3 relay, as shown in FIG. 6b. The basestation may broadcast the L3 relay indication via system information block (“SIB”). The L3 relay capable UE may initiate the relay discovery procedure and act as relay when necessary.

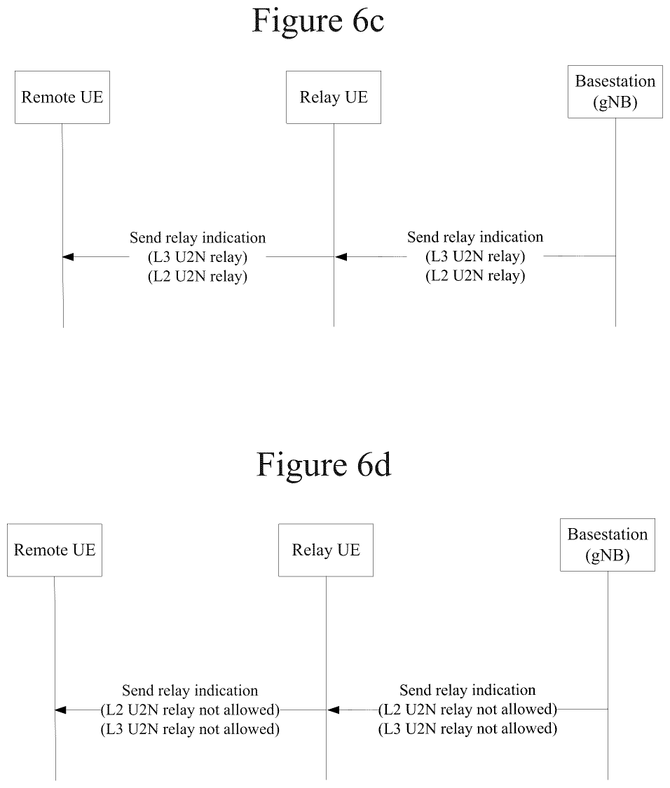

FIG. 6c shows relay communications for a basestation that supports both layer 2 and layer 3. The relay indication indicates that the basestation supports both L2 and L3 relay. The basestation may broadcast the L2 relay indication as well as the L3 relay indication. For the relay UE, it may send its L2 and or L3 relay indication to the basestation. For example, for the L2 relay capable relay UE, when it sends the L2 relay indication to the basestation, the basestation may configure the Uu RLC channel for the relay UE. Alternatively, if the UE is capable of both L2 and L3 relay and the UE wants to act as both an L2 and an L3 relay, it may send both L2 and L3 relay indications to the basestation as in FIG. 6c and FIG. 7.

FIG. 7 shows relay communications for sending a relay indication to a basestation. The relay indications 702 are sent from the relay UE for L2 and L3 indications to the basestation. The basestation then checks the UE authorization 704 for determining whether the relay UE is authorized for L2 or L3 relay communications. The UE authorization status may include ProSe Direct Discovery and ProSe Direct Communication (i.e. as 5G ProSe UE for ProSe Direct Discovery, as 5G ProSe UE for ProSe Direct Communication), UE-to-Network Relay Discovery and Communication (i.e. as 5G ProSe Layer-2 Remote UE, as 5G ProSe Layer-2 UE-to-Network Relay, as Layer-3 UE-to-Network Relay)). If the relay UE is capable of L3 relay, the basestation may send the Sidelink Tx resource configuration 706 to UE. If the UE is capable of L2 relay, gNB may send the sidelink Tx resource configuration 706 as well as the Uu RLC channel configuration 706 to the relay UE. The Uu RLC channel can be used by the relay UE to forward the remote UE's SRB0/1/2/3 signalling to the basestation.

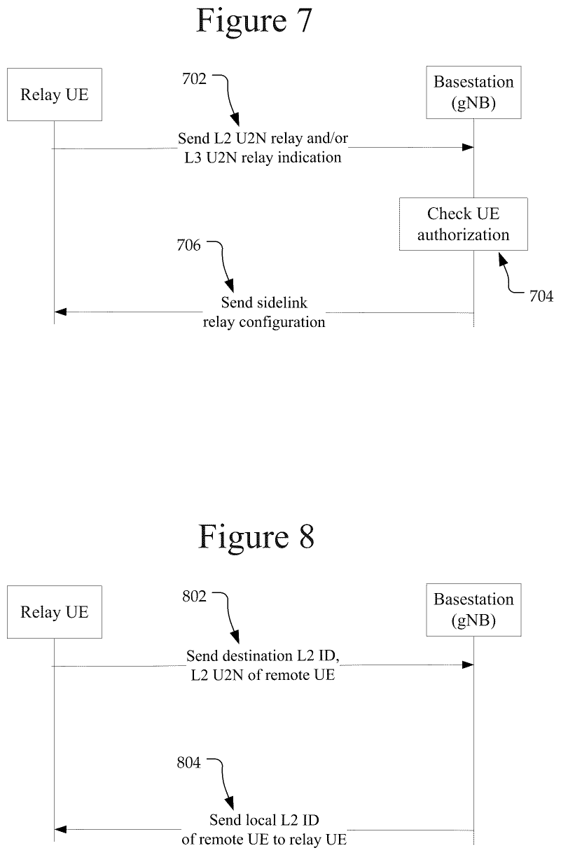

FIG. 8 shows relay communications for sending destination identification to a basestation. When the relay UE reports the destination L2 ID 802 of the remote UE to the basestation via a SidelinkUEInformation message, the relay UE may indicate which destination L2 ID is for L2 remote UE. Based on this info, the basestation may allocate a local ID 804 for the L2 remote UE for subsequent remote UE's traffic forwarding, as shown in FIG. 8. In other embodiments, the relay UE may report the destination L2 ID of remote UE together with the local L2 ID assigned by the relay UE to the basestation via a SidelinkUEInformation message. Based on this information, the basestation may associate the L2 local ID with the destination L2 ID of the remote UE.

When the remote UE is capable of both L2 and L3 relay communications, the remote UE may send an indication of preference for the layer. The remote UE may prefer L2 remote UE or L3 remote UE. The preference may be communicated with the basestation. The basestation may know the preference based on the UE authorization (704 in FIG. 7). However, the basestation may not know the remote UE's L3 capability. In an example, where the remote UE prefers to be L3 and indicates this preference to the basestation, the basestation may not consider the potential path switch for the remote UE. The service continuity may be up to remote UE's implementation.

FIG. 6d shows relay communications for a basestation that supports neither layer 2 or layer 3. The relay indication indicates that the basestation supports neither L2 or L3 relay. In one embodiment, this lack of support may not be broadcast by the basestation. Rather, support would be explicitly broadcast, while no broadcast would indicate no support. In some embodiments, the basestation may prohibit the autonomous L3 relay based on pre-configuration. So the basestation may indicate the UE-to-Network relay is not allowed. This relay indication can be used to prohibit the L3 relay capable UE to act as UE-to-Network relay when served by certain basestation (i.e. basestation that are preconfigured not to support that relay).

When the L3 UE-to-Network relay is not prohibited, the L3 relay capable UE may initiate the relay discovery procedure with the pre-configured sidelink (“SL”) configuration. In this embodiment, a non-access stratum (“NAS”) authorization for L3 relay could be used. For the basestation, it may not receive the UE authorization status such as 5G ProSe Layer-2 Remote UE, 5G ProSe Layer-2 UE-to-Network Relay, Layer-3 UE-to-Network Relay. The basestation may actually not be aware of the L3 relay.

### User Equipment Layer Support

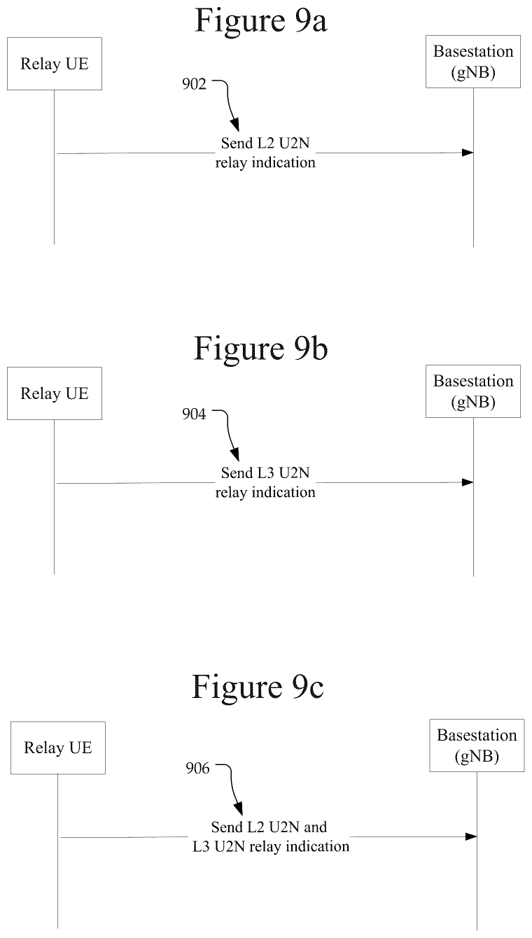

FIGS. 9a-9c illustrate relay communications regarding relay capabilities for the UE. Specifically, some UEs may only support L2, may only support L3, may support both L2 and L3, or may support neither. The UEs relay layer capabilities may vary for each individual UE resulting in different capabilities for a remote UE and a relay UE. The relay service code included in the relay discovery message may indicate whether the UE-to-Network relay is L3 or L2 relay. In some embodiments, the L2 remote UE may select the relay UE when the relay service code indicate L2 relay support. Likewise, the L3 remote UE may select the relay UE when the relay service code indicates L3 relay support. For a relay UE that is capable of both L2 and L3 relay, it may broadcast separate relay discovery message which include different relay service codes for L2 and L3 relay indications respectively. If the remote UE is capable of both L2 and L3, it may select either an L2 relay UE or an L3 relay UE. If both L2 relay UE and L3 relay UE are available, whether L2 relay or L3 relay shall be selected may be determined by the remote UE's implementation. Alternatively, the remote UE may receive a relay selection policy from upper layer/5GC/RAN, which may indicate L2 relay preferred or L3 relay preferred. When an L2 relay indication is received, the remote UE may prioritize the L2 relay selection.

FIG. 9a shows relay communications for sending a relay indication to a basestation that supports layer 2. Specifically, the relay UE supports only L2 relay. In this embodiment, the relay UE sends the discovery message 902 which includes the relay service code indicating it is an L2 relay. If the remote UE accesses this relay UE and indicates it is a L2 U2N relay in an L2 link establishment message (e.g. PC5 RRC message), the relay UE knows that it is for relaying purpose and then may initiate the RRC connection with the basestation. This connection may be initiated with a new establishment cause value. The relay UE may indicate to the basestation that the remote UE is a L2 remote UE and the local remote UE ID should be assigned by the basestation. In other embodiments, the relay UE notifies the remote UE about the local remote UE ID assigned by the relay UE. In some embodiments, the local remote UE ID may be configured to the remote UE through a Uu RRC or PC5 RRC message.

FIG. 9b shows relay communications for sending a relay indication to a basestation that supports layer 3. Relay UE support only L3 relay. In this embodiment, the relay UE send the discovery message 904 which includes the relay service code indicating it is L3 relay. When the remote UE accesses this relay UE and indicates it is L3 U2N remote UE in L2 link establishment message/PC5 RRC message, the relay UE knows that it is for relaying purpose and may initiate the RRC connection with the basestation (e.g. with new establishment cause value).

FIG. 9c shows relay communications for sending a relay indication to a basestation that supports both layer 2 and layer 3. The relay UE supports both L2 and L3 relay as evidenced by the relay service code transmitted with the relay indication. In alternative embodiments, the same relay UE may transmit separate discovery messages (not shown) to indicate its L2 or L3 relay support. For the nearby remote UEs, they may access the relay UE for L2 or L3 relay respectively. For the relay UE to determine the remote UE's supported relay type, the remote UE may send its L2 remote UE and or L3 remote UE capability indication 906 to the relay UE. In some embodiments, the remote UE may select whether to access the L2 relay or L3 relay. The remote UE sends the relay service code in the L2 link establishment message, which may be used by the relay UE to identify the access of the L2 or L3 remote UE. Alternatively, if the L2 relay UE ID is different for L2 or L3 relay, the L2 relay UE ID may be used to identify whether the L2 or L3 remote UE accesses the relay.

### Establishment Cause Value

During RRC establishment or resume (in L2), the relay UE may indicate the establishment cause value for the basestation to decide whether accept or reject the request. Upon receiving the first RRC message from the remote UE, if the relay UE had not started in RRC_CONNECTED, the relay UE may do its own connection establishment/resume process. The relay UE can indicate to the basestation that its establishment/resume cause is to relay remote UE's traffic. The establishment/resume cause value of the relay UE can set differently in different embodiments discussed below.

In one embodiment, an existing establishment/resume cause value can be reused. In one example, the relay UE may set the establishment/resume value in the AS layer based on the cause value provided by the upper layer.

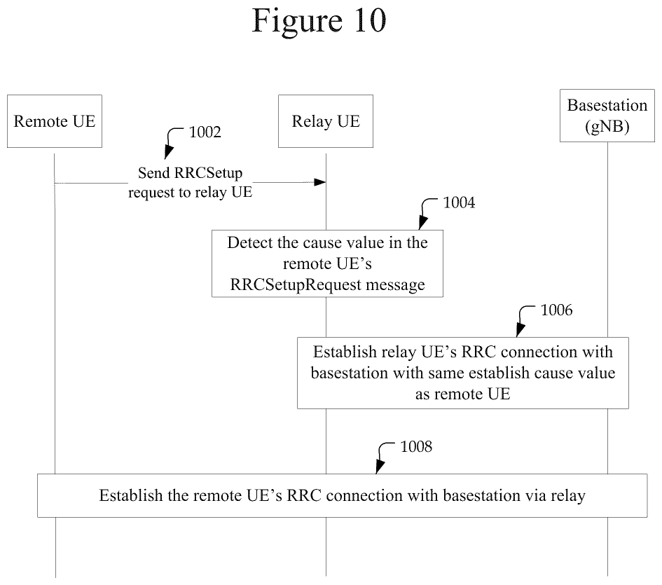

FIG. 10 shows relay communications with a setting of an establishment clause value in another example. The relay UE may set the establishment/resume cause in AS layer with the same value as RRCsetuprequest/RRCresumeRequest message 1002 received from the remote UE. The RRCsetuprequest/RRCresumeRequest message may be part of an Signaling Radio Bearer SRB0 message that may not be encrypted. The relay UE is able to detect the establishment/resume cause value 1004 from the first RRC message delivered via the PC5 RLC channel with a fixed specification. The relay UE can perform its own connection establishment/resume 1006 and set the establishment/resume cause with the detected value 1008.

Relay UE may obtain the establishment/resume value via PC5 signalling with the remote UE. In one example, the remote UE may send the establishment/resume cause value to the relay UE through a RRCReconfigurationSidelink message before the remote UE sends the first RRC message to the relay UE. Once the relay UE gets the establishment/resume cause of the remote UE, the relay UE may initiate its own RRC connection setup/resume with the corresponding establishment/resume cause.

In another embodiment, there may be a new establishment/resume cause value for the relay UE. In one example, a new AS layer establishment/resume cause value may be designed, such as “a relay” or “remote-LIE-establishment via relay” or “remote-UE-resume via relay.” Upon receiving the “relay” establishment/resume cause, the basestation may prioritize the relay UE's connection setup. This establishment/resume cause value may be set in the AS layer without upper layer involvement.

In another example, when the remote UE detects Uu/PC5 Radio Link Failure (“RLF”), it may re-select a relay UE and send the RRCReestablishmentrequest to the basestation for Uu recovery. When the relay UE is in RRC IDLE/INACTIVE state, it may need to establish/resume its own RRC connection. The potential cause values in RRCReestablishmentrequest include reconfigurationFailure, handoverFailure, otherFailure, but it is possible that the establishment/resume cause value is extended to include the reconfigurationFailure, handoverFailure, and/or otherFailure. Alternatively, the indication may be the “remote-UE-reestablishment via relay” as one establishment/resume cause value.

In another example, another way to design a establishment/resume cause value, includes a remote-LIE-emergency, remote-UE-highPriorityAccess, remote-UE-mt-Access, remote-UE-mo-Signalling, remote-UE-mo-Data, remote-UE-mo-VoiceCall, remote-UE-mo-VideoCall, remote-UE-mo-SMS, remote-UE-mps-PriorityAccess, remote-UE-mcs-PriorityAccess, remote-UE-rna-Update, remote-UE-reconfigurationFailure, remote-UE-handoverFailure, and/or remote-UE-otherFailure. Although exemplary, there may be a limitation to the spare values for the establishment clause which limits potential example values. For example, there may be only six spare values for establishment cause and five spare values for resume cause, which would limit new establishment/resume cause values. Another example embodiment would be to add a new IE in the RRCSetupRequest and RRCResumeRequest message. This new IE may indicate the relay and the legacy cause is used to set the remote UE's establishment/resume cause value.

### Relay Access

For L2 UE-to-Network relay, the Relay UE may provide unified access control (“UAC”) parameters to the remote UE. The access control check is performed at the remote LIE using the parameters of the cell it intends to access. The relay LIE may not perform access control check for the remote UE's data. There may be an access attempt barring check that is associated with a given Access Category (“AC”) and one or more Access Identities (“AI”). Given that the relay UE may include communications from other remote UEs, there must be a process for setting the AC for the relay UE when it intends to access network only for the purpose of relaying but not for its own service.

In one embodiment, there may be a new Access Category (“AC”) for the relay UE. There may be a higher priority for the relay UE's AC that is used specifically for relay communications. For example, the barring factor associated with this new AC may be configured to always allow the relay access.

In another embodiment, there may be an existing AC that is reused. For example, an existing AC 8 (e.g. MO signalling on RRC level resulting from other than paging). The prioritization may need to be modified for the existing AC so that access is allowed for the relay UE which attempts to access solely for relay communications.

In another embodiment, the relay UE may receive the AC from the remote UE via the PC5 interface. This AC may be used for the relay UE's UAC. This alternative embodiment, may rely on a PC5 signalling enhancement. In some examples, even if the same AC is used for the relay UE and the remote UE, they may have different UAC barring results due to the random number generated.

In some embodiments, the remote UE may not be barred while the associated relay UE is barred. In this example, the remote UE may be essentially barred. If the access attempt is barred for the relay UE, the T390 timer ((0.7+0.6*rand)*uac-BarringTime) can be started. The relay UE may not attempt to access until the T390 time expires and the barring is removed. Alternatively, when the remote UE transmits the RRCSetupRequest/RRCResumeRequest message, it may start the T300/T319 timer. When the T300/T319 timer expires, the remote UE may inform upper layers about the failure to establish the RRC connection, upon which the procedure ends. It may be that the T300/T319 timer expires during the barring time of the relay UE, so the relay UE may send a PC5 indication to the remote UE about the UAC barring and or barring timer.

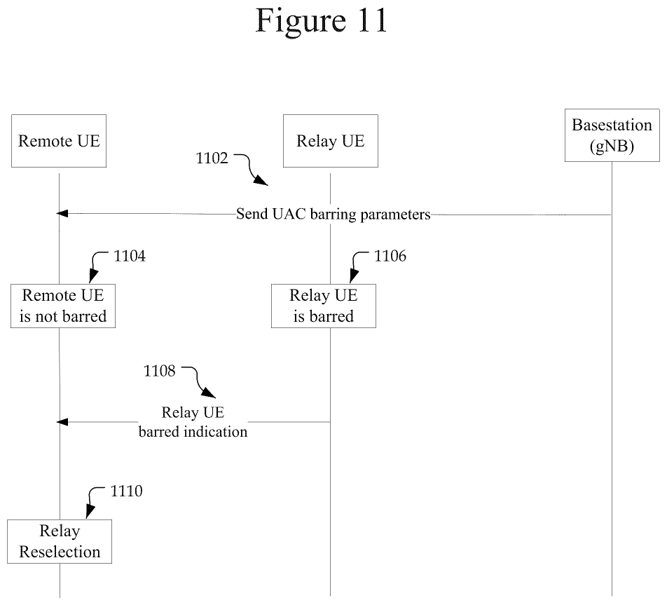

FIG. 11 shows relay communications including access restrictions. The barring parameters (for access restrictions, such as ACs) are sent for the basestation to the remote UE 1102. In the example of FIG. 11, the remote UE is not barred 1104 and the relay UE is barred 1106. The relay UE provides an indication 1108 that it is barred. Upon receiving such indication, the remote UE may reselect another relay UE 1110. Alternatively, it may pause its T300/T319 timer, which can be resumed when another PC5 indication is received from the relay UE which indicates the removal of the relay UE's UAC barring

In an alternative embodiment, a new AC and or AI may be defined for dedicated UAC control of the relay UE. In this example, a mapping table may be specified between the AI/AC and establishment value. The RAN may set a separate set of AC parameters for the new AC or AI.

### Relay Paging

Paging operations in the network may operate differently for relay communications. A paging occasion (“PO”) message source must be determine. For example, in order to monitor the remote UE's PO on behalf of the remote UE, the relay UE may obtain the remote UE's PO information. The frame in which a UE wakes up may be referred to as a paging frame (“PF”). Within a radio frame, there may be subframes and the UE does not remain awake in all 10 subframes. It may wake up in a specific subframe(s) within a paging frame which is/are called a paging occasion (“PO”).

In one embodiment, the PO may be calculated as follows:

The paging frame (“PF”) and PO for paging may be
determined by the following formula:

```
System Frame Number (“SFN”) for the PF is determined by:
  (SFN + PF_offset) mod T = (T div N)*(UE_ID mod N)
Index (i_s), indicating the index of the PO is determined by:
  i_s = floor (UE_ID/N) mod Ns
T: Discontinuous Reception (“DRX”) cycle of the UE (T is determined by the shortest of the UE specific DRX value(s), if configured by RRC and/or upper layers, and a default DRX value broadcast in system information. In RRC_IDLE state, if UE specific DRX is not configured by upper layers, the default value is applied).
N: number of total paging frames in T
Ns: number of paging occasions for a paging frame (“PF”)
PF_offset: offset used for paging frame (“PF”) determination
UE_ID: 5G-S-TMSI (Temporary Mobile Subscriber Identity) mod 1024
```

The UE may use Discontinuous Reception (“DRX”) in RRC_IDLE and RRC_INACTIVE state in order to reduce power consumption. The UE may monitor one paging occasion (“PO”) per DRX cycle. APO may be a set of PDCCH monitoring occasions with multiple subframes. The PF and PO may be determined by the UE-specific DRX cycle T and UE_ID value as well as the cell-specific Ns, N and PF_offset value. In order to monitor the PO of the remote UE, the relay UE may at least obtain the remote UE's DRX cycle T and UE_ID information. With regard to the UE_ID, there are several alternative embodiments for the acquisition of the remote UE's identification: UE_ID. The options include sending the 5G-S-TMSI of remote UE, utilizing a pseudo UE_ID (e.g. 5G-S-TMSI mod 1024) of the remote UE, or calculating the PO(s) of the remote UE.

In one embodiment, the 5G-S-TMSI is also used for paging the remote UE in the paging message, so the relay UE can precisely determine whether the remote UE is paged or not. Otherwise, the relay may be unable to determine the specific remote UE(s) indicated in a received paging message. In this embodiment, the relay UE sends the paging messages received within the PO to the remote UE. However, exposing the 5G-S-TMSI may present a potential security risk since it may expose the 5G-S-TMSI of the remote UE to the relay UE over the PC5 interface. In addition, RRC_INACTIVE remote UE may send the I-RNTI (Radio Network Temporary Identifier) to the relay UE so that the relay UE can determine the RAN Based Notification Area (“RNA”) paging of the remote UE.

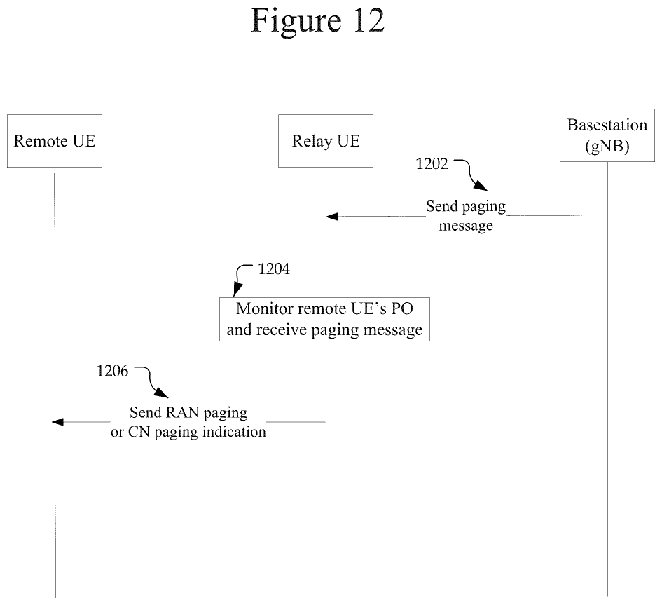

FIG. 12 shows relay communications with a paging indication. When there is not a security concern the 5G-S-TMSI/I-RNTI of the remote UE may be directly provided to the relay UE. In this example, the relay UE may precisely determine whether an associated remote UE is paged or not by monitoring the remote UE's PO 1204 and receiving the paging message 1202 when there is a page. When there is a page, the relay UE may send the paging indication 1206 (CN paging, RAN paging) to the specific remote UE. The paging indication may be delivered via PC5 RRC message or MAC CE.

When there may be a security concern over the exposure of remote UE's 5G-S-TMSI/I-RNTI to relay UE, the relay UE may be only aware of the 5G-S-TMSI mod 1024 and no I-RNTI. In this example, the relay UE may receive the paging message on the relevant PO, however, the relay UE may not determine whether the associated relay UE is paged or not.

The relay UE can forward the whole paging message received in the PO to the relevant remote UE. For example, the PO message may be delivered to the remote UE via an RRC Container in the PC5 message. Alternatively, if the relay UE knows the RRC state of the remote UE, the relay UE may only send the RAN paging to the RRC_INACTIVE remote UE, and send the CN paging to the RRC_IDLE remote UE. Considering that multiple remote UE may need to receive the same paging message (e.g. mapped to the same PO), the relay UE may design a new destination L2 ID which is used for the groupcast of paging messages via PC5 interface. The relay UE may notify the remote UE of this destination L2 ID for paging when the remote UE establishes connection with the relay UE or when the remote UE asks the relay UE to forward the paging for it.

### Short Messages in Relay Communications

Short message may be transmitted on physical downlink control channel (“PDCCH”) using P-RNTI (Radio Network Temporary Identifier) with or without an associated paging message using the Short Message field in Downlink Control Information (“DCI”) format 1_0. The following table identifies exemplary short messages:

| Bit | Short Message |
|---|---|
| 1 | systemInfoModification |
| | If set to 1: indication of a Broadcast Control Channel |
| | (“BCCH”) modification other than SIB6, SIB7 |
| | and SIB8. |
| 2 | etwsAndCmasIndication |
| | If set to 1: indication of an Earthquake and Tsunami |
| | Warning System (ETWS) primary notification and/or |
| | an ETWS secondary notification and/or a Commercial |
| | Mobile Alert System (CMAS) notification. |
| 3 | stopPagingMonitoring |
| | This bit can be used for only operation with shared |
| | spectrum channel access and if nrofPDCCH- |
| | MonitoringOccasionPerSSB-InPO is present. |
| | If set to 1: indication that the UE may stop monitoring |
| | PDCCH occasion(s) for paging in this PO |
| 4-8 | Not currently used |

Not just the RRC_IDLE/INACTIVE UE, but also any RRC_CONNECTED UE can monitor the short message and detect the system information (“IS”) change indication and Earthquake and Tsunami Warning System (ETWS) and Commercial Mobile Alert System (CMAS) notification. For the stopPagingMonitoring short message, it may be used by the relay UE to stop the paging monitoring in this PO. This short message maybe applied to all UE interested in this PO. In some embodiments for the paging message, the RRC_IDLE/INACTIVE UEs may be the only UEs monitoring and receiving.

For the remote UE, it may not directly monitor the short message via the Uu interface. However, the relay UE may notice the potential change via the systemInfoModification and/or the etwsAndCmasIndication, and receive an updated SIB or SI message. For a RRC_CONNECTED remote UE supporting on-demand SI acquisition, it may get the updated SIB from the basestation since the basestation knows which SIB the remote UE has interest or has demanded before.

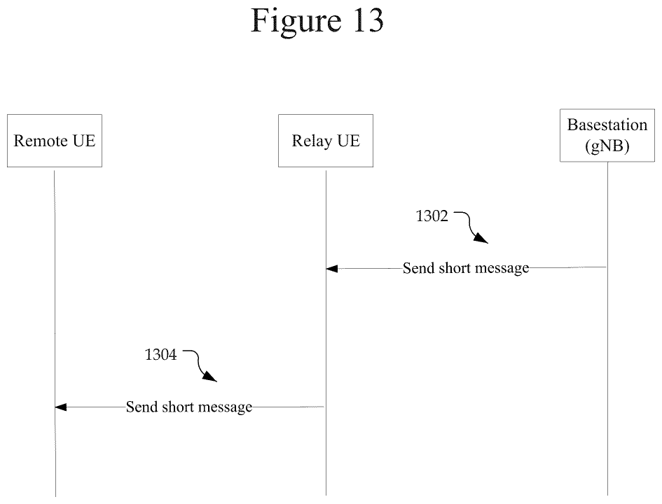

FIG. 13 shows relay communications with paging for system information. When the SIB updates, the basestation may push the updates 1302, 1304 to the remote UE. When the basestation does not support the push of an SI update, the relay UE may forward the systemInfoModification and etwsAndCmasIndication (1302, 1304) via PC5 interface, as shown in FIG. 13. Based on these indications, the remote UE may receive the updated SIB via on-demand SI acquisition.

For an RRC_IDLE/INACTIVE remote UE, it may notify the relay UE that it is ETWS capable, CMAS capable, or directly notify the relay UE for its interested SIB. Once the relay UE detects an SI change which the associated remote UE has an interest in, then the relay UE shall forward the corresponding SIB to the remote UE.

For an RRC_Connected remote UE, the basestation may directly send the updated SI or SIB6/7/8 via a dedicated Uu RLC signalling to the remote UE when the basestation is aware of the remote UE's ETWS/CMAS capability or interested SIB. In this example, the relay UE does not need to monitor the POs of the RRC_Connected remote UE. Alternatively, if the SI change indication and the ETWS/CMAS notification is sent in the remote UE's PO, it may be that the same indication is also sent in the relay UE's PO. In this embodiment, the relay UE may monitor the POs of only RRC_IDLE/INACTIVE remote UEs.

The RRC_Connected UE may request the SIB when the onDemandSIB-Request is configured and the SI message which contains the required SIB and for which si-BroadcastStatus is set to notbroadcasting. The UE may send the DedicatedSIBRequest message to the basestation. When it comes to the RRC_Connected remote UE, the remote UE may be interested in a SIB which is set to notBroadcasting. In this example, the RRC_Connected remote UE also sends the SIB request to relay UE and the relay UE monitors the SIB and sends the acquired SIB to the remote UE via a PC5 message.

### Impact of PC5 RLF/UU RLF/Relay UE HO/Relay UE Resume on Relay Reselection

For PC5 radio link failure (“RLF”), relay reselection may be triggered if RLF of PC5 link with current relay UE is detected by the remote UE. For L3 relay, it may directly re-select another relay UE and establish the PC5 connection. There may be no service continuity enhancement in AS layer.

For L2 relay, when the cell ID is broadcast in a discovery message, it is possible for L2 remote UE to re-select a new relay UE which is served by the same cell as the old relay UE. In this example, the L2 remote UE may perform the RRC re-establishment procedure to recover the Uu RRC connection with the basestation (“gNB”). To support this example, the basestation should not immediately release the context of remote UE if the basestation receives the PC5 RLF report from the old relay UE. Instead, the basestation may keep the remote UE's context for potential re-establishment.

When the remote UE performs RRCReestablishment, it may transmit the RRCReestablishmentRequest message. The remote UE fills in the C-RNTI, PCI and short MAC-I. When the remote UE is initially connected to the basestation via relay UE, the basestation can assign the cell-specific remote UE Id (e.g. C-RNTI 16 bit) to the remote UE via Uu RRC Reconfiguration/RRCSetup message. In another example, the PCI may be sent to the remote UE via PC5 RRC message from the original relay UE or via Uu RRC message from the old basestation. In this way, the remote UE may recover at the new basestation.

The basestation may assign the C-RNTI to the remote UE via Uu RRC reconfiguration message. In addition, the remote UE's C-RNTI can be sent to the relay UE via PC5 (remote UE sent to relay UE) or Uu (basestation sent to remote UE). The remote UE's C-RNTI can be used in the adaptation layer of PC5 and Uu.

For Uu radio link failure (“RLF”) handover (“HO”), when Uu RLF is detected by the relay UE, the relay UE may send a PC5-S message to its connected remote UE and this message may trigger relay reselection. In another example, considering that the relay UE may recover the Uu link with the basestation, it may not be necessary for the remote UE to re-select another relay UE or switch to Uu link immediately, especially for RRC_IDLE/INACTIVE remote UEs which have no ongoing data transmission. The potential handling of the remote UE upon Uu RLF can be divided into following two examples:

1) RRC_CONNECTED remote UE: During this period, the relay UE may send the Uu RLF notification to an RRC_CONNECTED remote UE and the RRC_CONNECTED remote UE may trigger the relay re-selection. Alternatively, the remote UE may initiate the relay discovery procedure to find a nearby suitable relay UE. After a period of time, if the relay UE recovers the Uu link at original basestation, the relay UE may send the RLF recovery notification to the remote UE and the remote UE continues the PC5 transmission with this relay UE. In another example, if the relay UE recovers its Uu link at a new basestation or the relay UE's Uu RLF recovery fails, the relay UE may send a Uu recovery at a new basestation notification to its connected remote UE(s) and this message may trigger the RRC_CONNECTED remote UE to switch to a direct Uu link or re-select another relay UE.

2) RRC_IDLE/INACTIVE remote UE: the RRC_IDLE/INACTIVE remote UEs may keep the PC5 connection with the relay UE when the relay UE detects Uu RLF and performs Uu RRC recovery. Suppose the relay UE recovers its Uu link at a new basestation, it may still serve the RRC_IDLE/INACTIVE remote UE to forward the CN/RAN paging. In another example, if the relay UE's Uu link recovery fails, the relay UE enters RRC_IDLE. The relay UE could still forward the CN/RNA paging for RRC_IDLE/INACTIVE remote UE.

Accordingly, the RRC_Connected remote UE can re-select another relay as early as possible when a Uu RLF is detected by a connected relay UE. For the RRC_IDLE/INACTIVE remote UE, it may keep the PC5 connection with the relay UE even if the relay UE detects RLF and enters the RRC_IDLE state. The relay UE may only need to send the Uu RLF notification/PC5-S message to RRC_CONNECTED remote UEs.

Considering that the relay UE may recover the Uu link with the basestation, the relay UE may send the Uu RLF notifications, such as Uu RLF detected, Uu RLF recovered, Uu recovery failed, Uu recovery at a new basestation, etc., which can be used by the remote UE to determine whether and when the relay/cell re-selection should be performed.

When the relay UE detects Uu RLF, the relay UE may only need to send RLF notification/PC5-S message to RRC_CONNECTED remote UE. For the RRC_IDLE/INACTIVE remote UE, it may keep the PC5 connection and receive paging forwarding from the relay UE even if the relay UE enters RRC_IDLE state.

For RRC resume at the new basestation, when the UE moves from RRC_INACTIVE to RRC_INACTIVE, it may need to store the inactive AS context, such as the current KgNB and KRRCint keys, the Robust Header Compression (“ROHC”) state, the stored Quality of Service (“QoS”) flow to data radio bearer (DRB) mapping rules, the C-RNTI used in the source PCell, the cellIdentity and the physical cell identity of the source PCell, the spCellConfigCommon within ReconfigurationWithSync of the PSCell (if configured) and all other parameters configured except for the ones within ReconfigurationWithSync of the PCell and servingCellConfigCommonSIB. In other examples, UE resets MAC and releases the default MAC Cell Group configuration if any, re-establishes RLC entities for SRB1, suspends all SRB(s) and DRB(s), except SRB0, and indicates Packet Data Convergence Protocol (PDCP) suspend to lower layers of all DRBs. When the UE enters RRC_INACTIVE, the PDCP entity is kept, the RLC entity is released. However, the RLC relevant configuration may be kept. When the UE moves from RRC_INACTIVE to RRC_CONNECTED, the basestation may only provide delta configuration.

In other examples, when the UE plans to resume the RRC connection with Uu and before it sends the RRCResumeRequest, it may restore the RRC configuration, RoHC state, the stored QoS flow to DRB mapping rules and the KgNB and KRRCint keys from the stored UE Inactive AS context, update the KgNB and KRRCint, re-establish PDCP entities for SRB1, resume SRB1. Upon receiving the RRCResume message from the basestation, the UE performs the MCGCellGroup configuration, radio bearer configuration, resume the SRB2/SRB3/DRB and enter RRC_CONNECTED state.

When it comes to the relay UE, the adaptation layer configuration at the relay UE may include the bearer mapping configuration, the local ID of associated RRC_Connected remote UE, the PO/5G-S-TMSI/I-RNTI of associated remote UE, etc.

With regard to the basestation, it may store the relay UE's SRB/DRB configuration, as well as the associated RRC_Connected remote UE's local ID as the relay UE's context. For the RRC_IDLE/INACTIVE remote UE, the basestation may not store relevant NG/Uu context for these remote UEs. However, if the RRC_IDLE remote UE maintains the PC5 connection with the RRC_Connected remote UE, the basestation may still maintain the destination L2 ID of such remote UE. In addition, the basestation may also know that this destination L2 ID is associated with the remote UE. The basestation may assign the local remote UE ID in advance of this remote UE for the potentially subsequent Uu RRC signalling forwarding.

From the basestation perspective, for RRC_INACTIVE remote UE, the basestation may at least store the remote UE's SRB/DRB configuration. In addition, the basestation may store the association between RRC_Connected relay UE and this remote UE when the PC5 connection is maintained between the RRC_Connected relay UE and RRC_INACTIVE remote UE. When the RRC_INACTIVE remote UE re-selects to another RRC_Connected relay UE, the serving basestation of another relay UE may store the association between RRC_Connected relay UE and this remote UE as one of the content of relay UE's context. In other examples, when the RRC_INACTIVE remote UE re-selects to another RRC_INACTIVE relay UE and establishes the PC5 connection, the basestation may not store the association between RRC_INACTIVE relay UE and this RRC_INACTIVE remote UE.

The RRC_INACTIVE relay UE may perform RRC resume upon receiving the remote UE's first RRC signalling. Whether the relay UE performs its RRC resume at the original basestation or a new basestation, the relay UE may resume its RRC connection first and then forwards the remote UE's first RRC signalling to the basestation. Since the basestation does not store the context of RRC_INACTIVE relay UE and its associated remote UE, it may not be necessary to consider the context retrieval issue of both remote UE and relay when the relay UE performs RRC resume at new basestation.

The remote UE connected with RRC_INACTIVE relay UE may be in an RRC_IDLE or an RRC_INACTIVE state. For the RRC_IDLE/INACTIVE remote UE, it may keep the PC5 connection and receive the paging forwarding from the relay UE whether the relay UE resumes an RRC connection at the new basestation or not. It may not be necessary to trigger the relay (re)selection of a connected remote UE.

If the RRC_INACTIVE relay UE resumes an RRC connection at a new basestation, the connected RRC_IDLE/INACTIVE remote UE may keep the PC5 connection and receive the paging forwarding from the relay UE

The RRC resume of a remote UE and relay UE can be performed independently. It may not be necessary to consider the context retrieval issue of both the remote UE and the relay UE when the relay UE performs RRC resume at a new basestation.

### Discovery Resources Used by the Remote UE

The relay UE and remote UE (IC) in RRC CONNECTED can use the discovery configuration provided via dedicated signalling if available. The relay UE and remote UE (IC) in RRC IDLE or RRC INACTIVE shall use the discovery configuration provided via SIB if available.

The relay UE supporting L3 UE-to-Network Relay is allowed to transmit a discovery message based on at least pre-configuration when it is connected to a basestation which is not capable of sidelink relay operation, in case its serving carrier is not shared with a carrier for sidelink operation. The sidelink capable basestation may at least broadcast sidelink SIB. The sidelink SIB should include the sidelink Rx resource pool and optionally sidelink Tx resource pool. If no sidelink SIB is available, the relay/remote UE may regard the basestation as a non-sidelink-capable basestation and then use pre-configuration for discovery when the serving carrier of the basestation is not shared with a carrier for sidelink operation.

If the sidelink SIB is not provided by the basestation, a relay/remote UE may regard the basestation as a non-sidelink-capable basestation and use pre-configuration for discovery when the serving carrier of the basestation is not shared with a carrier for sidelink operation.

With regard to the sidelink capable basestation, the UE shall not perform new radio (“NR”) sidelink communication according to a SL-V2X-Preconfiguration if the UE detects a cell providing NR sidelink configuration or inter-carrier NR sidelink configuration for the frequency UE is interested in to perform NR sidelink communication on. When it comes to the UE-to-Network relay, the relay/remote UE can use preconfiguration for discovery if the sidelink carrier of discovery preconfiguration is neither the serving carrier of sidelink-capable basestation nor included in NR sidelink configuration within SIB12. The relay/remote UE can use preconfiguration for discovery if the sidelink carrier of discovery preconfiguration is neither the serving carrier of sidelink-capable basestation nor included in NR sidelink configuration within SIB12.

Furthermore, if the UE detects at least one cell on the frequency which UE is configured to perform NR sidelink communication on fulfilling the S criterion, it shall consider itself to be in-coverage for NR sidelink communication on that frequency. Otherwise, it shall consider itself to be out-of-coverage for NR sidelink communication on that frequency. For the out-of-coverage L3 remote UE, it can only use pre-configured sidelink discovery configuration. However, for L2 OOC remote UE, it can use the network configured sidelink discovery configuration if it is connected to sidelink-capable basestation. A sidelink-capable basestation may provide better network control for the remote UE. Otherwise, it may use pre-configured sidelink discovery configuration.

The sidelink discovery Tx resource configuration in SIB may only be used by RRC_IDLE/INACTIVE UE, and the discovery Tx resource configuration via dedicated signalling may only be used by RRC_CONNECTED UE. When the RRC_CONNECTED relay UE/remote UE cannot get the sidelink discovery Tx resource configuration from sidelink-capable basestation via dedicated signalling, it may be due to a failure of the relay/remote UE authorization or sidelink resource congestion. In this example, the RRC_CONNECTED relay/remote UE may not use the discovery Tx resource configuration from SIB. The RRC_CONNECTED relay/remote UE may use the sidelink discovery Tx resource configuration provided by dedicated signalling.

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A method for wireless communication comprising:
receiving an indication of relay capability;
acting as a relay based on the indication of the relay capability.

2. The method of claim 1, wherein the indication is received by a relay user equipment (“UE”) from a basestation and the relay UE acts as the relay between the basestation and a remote UE.

3. The method of claim 2, wherein the relay capability comprises that the basestation can support layer 2 relay only, can support layer 3 relay only, can support both layer 2 relay and layer 3 relay, or that relay is not allowed.

4. The method of claim 3, wherein when the relay capability can support both layer 2 and layer 3, the relay capability selected for the relay UE acting as the relay is based on an indication of preference from the remote UE or from an upper layer of relay UE.

5. The method of claim 1, wherein the acting as a relay comprises sidelink discovery or sidelink communication for relay operation.

6. The method of claim 1, wherein a system information block (“SIB”) includes the indication.

7. The method of claim 1 further comprising:
checking an authorization for UE-to-Network Relay discovery and communication based on the indication; and
sending a sidelink relay configuration based on the relay capability and the authorization.

8. The method of claim 7, wherein the relay capability can be a layer 2 relay only, a layer 3 relay only, or both a layer 2 relay and a layer 3 relay, the indication is provided from a relay capable user equipment (“UE”) to a basestation, and the basestation checks an indication about the UE authorization status for the UE-to-Network Relay.

9. A method for wireless communication comprising:
sending the indication of relay to a relay user equipment (“UE”) or a basestation; and
acting as a remote UE based on the indication.

10. The method of claim 9, wherein the sending is from the remote UE.

11. The method of claim 9, wherein the indication comprises that the remote UE supports L2 only, L3 only, or both L2 and L3.

12. The method of claim 9, further comprising:
receiving a relay selection policy from an upper layer or 5GC or RAN, which indicates a preference for an L2 relay or an L3 relay.

13. The method of claim 9, wherein the acting as the remote UE based on the indication of relay comprises sidelink discovery or sidelink communication for relay operation.

14. A method for wireless communication, comprising:
monitoring a paging occasion for a remote UE; and
sending, based on the monitoring, a paging indication to the remote UE.

15. The method of claim 14, further comprising:
receiving information for paging monitoring of a remote user equipment (“UE”) in a PC5 message.

16. The method of claim 14, wherein the relay UE receives a paging message from a basestation when monitoring the paging occasion for the remote UE.

17. The method of claim 14, wherein the monitoring and the sending is from a relay UE.

18. The method of claim 14, wherein the paging indication is delivered through a PC5 RRC message.

19. The method of claim 14, wherein the paging indication includes radio access network (“RAN”) paging or core network (“CN”) paging of the remote UE.

20. The method of claim 14, wherein the sending comprises forwarding a paging message to a plurality of remote UEs via groupcast.
